(19) United States
(12) Patent Application Publication
(10) Pub. No.: US 2016/0268726 A1
(43) Pub. Date: Sep. 15, 2016

(54) Corrosion Protected Communication Connections And Related Methods

(71) Applicant: Radio Frequency Systems, Inc., Meriden, CT (US)

(72) Inventors: Yin-shing Chong, Middletown, CT (US); Timothy Bernhardt, Cheshire, CT (US)

(73) Assignee: Radio Frequency Systems, Inc., Meriden, CT (US)

(21) Appl. No.: 14/656,233

(22) Filed: Mar. 12, 2015

(51) Int. Cl. H01R 13/533; H01R 13/52

(52) U.S. Cl. CPC H01R 13/533; H01R 13/5202

(57) ABSTRACT

Corrosion within a flangeless connector, or at an associated connection of a device or medium (e.g., cable), used in a wireless base station may be reduced by incorporating a recessed portion in an outer surface of a body of the flangeless connector. The recessed portion helps retain a seating member, such as a deformable O-ring, to prevent water and other environmental material from seeping into the connector or connection. Further, inner surfaces of a port of a device that receives the flangeless connector may be covered with a conductive plating, while outer surfaces of the port may be covered with a non-conductive coating.

### RELATED APPLICATION

This application is related to U.S. Patent Application Publication No. 2011/0182551 A1 (the “'551 application”) and incorporates by reference herein the disclosure of the '551 application, including text and figures, as if such disclosure were set forth in its entirety herein.

### INTRODUCTION

Existing wireless base stations utilize a number of different components, such as filters, amplifiers, transmitters and antennas all of which are typically connected using a variety of media, such as coaxial cable, fiber optic cable and conductive cabling (e.g., copper cables). At the junction of a cable and device there is typically a communications connector (“connector” for short) that joins or otherwise connects the cable to the device, for example.

The '551 application discloses some examples of a flangeless connector.

One longstanding issue is galvanic corrosion of the connector, or at a connection of a device or medium composed of dissimilar materials (e.g., metals), caused by environmental factors (e.g., water seepage, salt, pollution, etc.,) alone and/or when combined with heating of the connector, connection, device or medium during operation.

It is desirable to provide flangeless connectors and associated devices or media that are designed to prevent or reduce corrosion along with related methods that prevent or reduce corrosion.

### SUMMARY

Exemplary embodiments of flangeless, communications connectors and related methods for connecting such connectors to communications devices and media are described herein.

According to one embodiment, an inventive flangeless, communications connector may comprise a connector body configured with a recessed portion formed around an outer surface of the body to retainably receive a seating member, such as a deformable O-ring. The connector may be a mini-DIN connector (e.g., 4.1/9.5 min-DIN connector, 4.3/10 mini-DIN connector, 7/16 mini-DIN connector), or an N-type connector, for example. In addition, the connector may be further configured with one or more grip surface portions for rotatably adjusting the connector into a communications device, such as a filter, amplifier or transmitter, for example. These surfaces are named “grip” surface portions because they allow for a tool to grip a portion of a surface, or allow a person's hand to so grip such a portion to tighten, or loosen, (i.e., adjust) a connector. The grip surface portions may comprise flattened surface portions, raised surface portions, indents, or recessed holes, for example.

The incorporation of a recessed portion into a connector to retain and receive a seating member may aid in the reduction, and prevention, of corrosion by preventing water or other environmental elements from seeping into, or otherwise forming on, the connection formed by the connector and communications device. Further, the incorporation of grip surface portions may further aid in the reduction, and prevention, of corrosion by ensuring that an inventive connector is adequately fastened to a device or communications medium (e.g., cable) in order to prevent water or other environmental elements from seeping into, or otherwise forming on, the surfaces of the connector or device/medium involved in the connection.

In one embodiment the seating member may be an integral part of an inventive connector or device (e.g., pre-assembled as a part of an inventive connector). In another embodiment the seating member is a separate element. In the latter case, a seating member may be added to the connector or assembled with the connector or connection.

A connector body may be further configured with two oppositely positioned connection interfaces, where at least one of the oppositely positioned interfaces comprises threads for threadably connecting the connector to a device or communications medium (e.g., a communications medium selected from the group consisting of at least coaxial cable, optical fiber, and copper cable).

Inventive connectors provided by the present invention may be installed or otherwise connected to a system, device, medium or element as a separate component or, alternatively may be made an integral part of a system, device, medium or element prior to being installed or used. For example, in one embodiment a device, such as a filter, amplifier or transmitter to name just a few types of devices, may comprise an inventive flangeless, communications connector (e.g., mini-DIN connector or N-type connector). Similar to the inventive connectors described above (and herein) such an inventive, flangeless communications connector may comprise a connector body configured with a recessed portion formed around an outer surface of the body to retainably receive a seating member (e.g., a deformable O-ring), and further configured with one or more grip surface portions to rotatably adjust the connector. In one embodiment the connector is a 4.1/9.5 mini-DIN connector or 4.3/10 mini-DIN connector. In another embodiment the connector is a 7/16 mini-DIN connector. In yet a fourth embodiment the connector is an N-type connector.

In various embodiments, the seating member may be an integral part of an inventive connector, device or medium (e.g., pre-assembled as a part of an inventive connector, device or medium). In another embodiment the seating member is a separate element. In the latter case, a seating member may be added to the connector, device or medium, or assembled with the connector, device, medium or connection.

Yet further, a connector used as a part of a device may be further configured with two oppositely positioned connection interfaces, where at least one of the two oppositely positioned interfaces comprises threads for connecting the connector to another device, or medium, for example.

In addition to inventive connectors, the present invention also provides additional, inventive devices (e.g., filters, amplifiers or transmitters, etc.,) that may be used with inventive flangeless, communication connectors (e.g., mini-DIN connectors, N-type connector). In one embodiment, an inventive communications device may comprise a port or receptacle that may be configured to receive a flangeless connector, where inner surfaces of the port comprise conductive plating and outer surfaces of the port comprise an aluminum or polymer surface covered by a non-conductive coating (e.g., powder coating, paint). The conductive plating may comprise copper plating, for example.

Yet further, the communications device may further comprise an extended port for receiving a connector to aid in the ease of installation of the connector and to help reduce corrosion.

In addition to connectors and devices, the present invention provides related methods for connecting an inventive flangeless, communications connector (e.g., mini-DIN connector or an N-type connector) to a communications device. In one embodiment, an exemplary method includes positioning a connector, such as a 4.1/9.5 mini-DIN connector, a 4.3/10 mini-DIN connector, or a 7/16 mini-DIN connector, or an N-type connector, for example. The so-positioned connector may comprise a deformable seating member, such as an O-ring, in a recessed portion formed around an outer surface of a body of a threaded, flangeless connector configured to retainably receive the seating member; and, securing the connector to, or into, a communications device by applying a force (e.g., a rotatable force) to grip surface portions of the connector's body.

Additional embodiments and features will be apparent from the following detailed description and appended figures.

### BRIEF DESCRIPTION OF THE FIGURES

FIG. 1a depicts a system that includes exemplary connectors and devices according to an embodiment of the invention.

FIG. 1b depicts a cross-sectional view of an exemplary connector in accordance with one embodiment that may be used in the system depicted in FIG. 1a, for example.

FIG. 2 depicts a simplified, enlarged cross-sectional view of a section of an exemplary connector according to an embodiment of the present invention.

FIG. 3 depicts an exemplary connector shown connected to an exemplary device according to an embodiment of the present invention.

FIG. 4 depicts an exemplary connector shown connected to another exemplary device according to an embodiment of the present invention.

FIG. 5 depicts an exemplary port or receptacle of a device that may be configured to receive an exemplary connector according to an embodiment of the present invention.

### DETAILED DESCRIPTION, WITH EXAMPLES

Exemplary embodiments of flangeless, communications connectors, related devices and media, and related methods for connecting inventive connectors with devices or media are described herein and are shown by way of example in the figures. Throughout the following description and figures, like reference numbers/characters refer to like elements.

It should be understood that, although specific exemplary embodiments are discussed herein, there is no intent to limit the scope of the present invention to such embodiments. To the contrary, it should be understood that the exemplary embodiments discussed herein are for illustrative purposes, and that modified and alternative embodiments may be implemented without departing from the scope of the present invention.

It should also be understood that one or more exemplary embodiments may be described as a process or method. Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method.

As used herein, the term “and/or” includes any and all combinations of one or more of the associated listed items. As used herein, the singular forms “a,” “an” and “the” are intended to include the plural form, unless the context and/or common sense indicates otherwise. As used herein the word “member” is intended to include the plural form, unless the context and/or common sense indicate otherwise. It should be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The phrases “communications connector”, “communication connector”, “flangeless connector” and “connector” may be used interchangeably herein.

It should be understood that when a system, device, medium or element is referred to as being “connected” to or “joined” to (or other tenses of connected and joined) another system, device, medium or element or “installed” or “used” in (or another tense of installed or used) another system, device, medium or element such systems, devices, media or elements can be directly connected or joined to, or installed or used in, other or intervening systems, devices, media or elements to aid a connection, junction or installation. In the latter case, if the intervening systems, devices, media and elements are well known to those in the art they may not be described herein.

As used herein, the term “embodiment” refers to an example of the present invention.

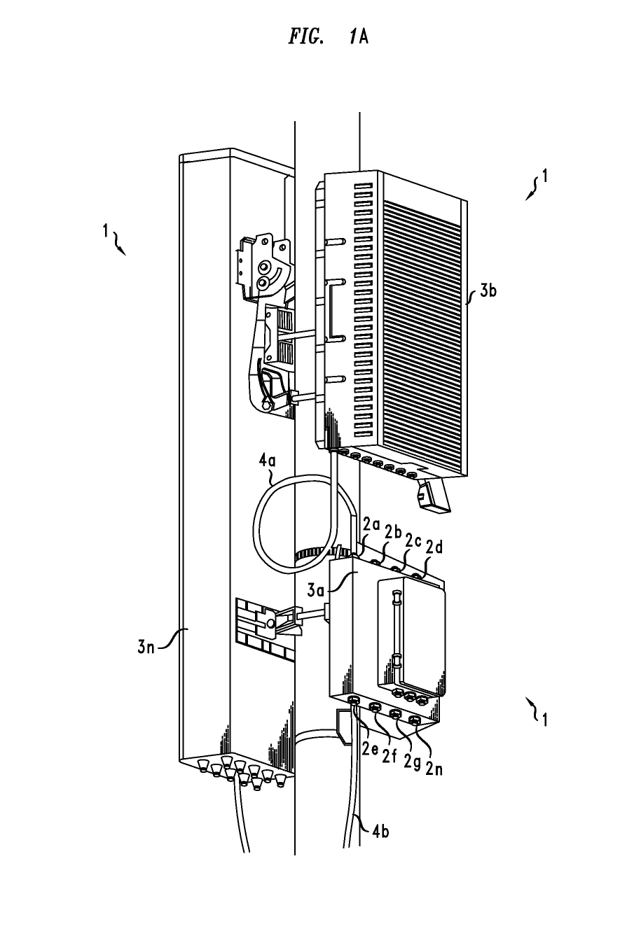

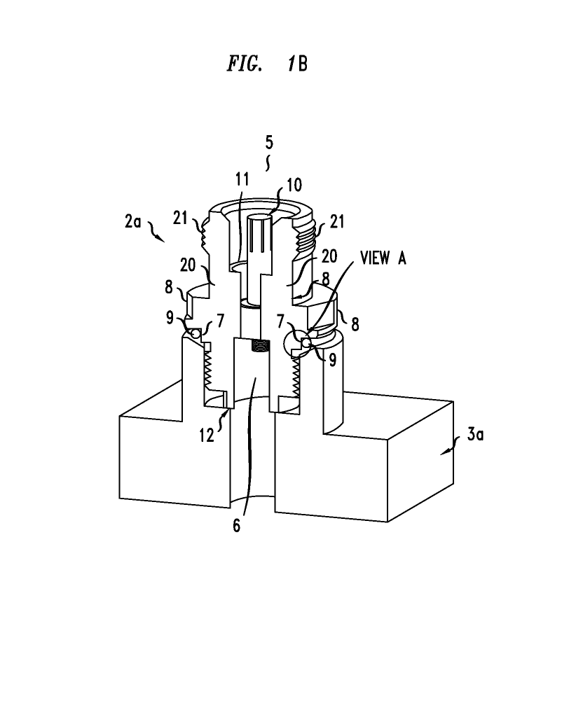

Turning to FIG. 1a, there is depicted a system 1 that includes exemplary, inventive flangeless communications connectors 2a through 2n (where “n” is the last connector) and devices 3a through 3n (where “n” is the last device) according to an embodiment of the invention. System 1 may comprise a transmission system used as a part of a wireless, communications base station, for example.

As shown, connectors 2a through 2n may be used to connect separate devices 3a, 3b, . . . 3n using communications media 4a and 4b. For example, device 3a may be a communications filter (e.g., radio frequency (RF) filter, where RF designates a commonly used descriptor for a filter, amplifier, transmitter or base station and not, strictly speaking, the frequency range of the filter, amplifier, transmitter or base station), device 3b may be a communications or network radio, and device 3n may be an antenna. Although only three types of devices are shown, it is should be understood that many types of communications devices commonly used as a part of an RF base station may be connected using exemplary connectors 2a through 2n. Another commonly connected device is an RF amplifier, to name just one example.

Inventive connectors 2a-2n may be operable to operate over a wide range of frequencies. Exemplary ranges are DC to 14 GHz (when a connector 2a-2n is a 4.1/9.5 mini-DIN connector), DC to 7.5 GHz (when a connector 2a-2n is a 7/16 mini-DIN connector) or 0 to 11 GHz (when a connector 2a-2n is an N-type connector) to name just a few of the many ranges within the scope of the present invention. Media 4a and 4b may comprise the same or a different type of communication medium, such as coaxial cable, fiber optic cable, or copper cable, for example.

Referring now to FIG. 1b, this figure depicts a cross-sectional view of an exemplary flangeless, communications connector, such as connector 2a in FIG. 1a, in accordance with one embodiment.

As shown the connector 2a may be connected to a device, such as a filter 3a in FIG. 1a. Connector 2a may include a body 20. Although body 20 is shown as cylindrical, this is merely exemplary. In additional embodiments body 20 may take the form of other shapes as well, such as polygonal, rectangular and elliptical. In an embodiment of the invention, body 20 may be configured with two oppositely positioned connection interfaces 5, 6. Still further, body 20 may be further configured to include a recessed portion 7 formed around an outer surface 8 of the body 20 for retainably receiving a seating member 9. In one embodiment the seating member 9 may be an integral part of connector 2a (e.g., pre-assembled as a part of a connector 2a). In another embodiment the seating member 9 is a separate element. In the latter case, a seating member 9 may be added to the connector 2a or assembled with the connector 2a or connection.

Interfaces 5, 6 may be configured to physically join different devices, media or elements to connector 2a. Interfaces 5, 6 may include a number of different types of structures or configurations, such as threads, fasteners, augur/tang, adhesive, and/or locking type connections. The interfaces 5, 6 may be similar or may be different. In the embodiment depicted in FIG. 1b at least one of the oppositely positioned connection interfaces, in this case interface 5, comprises threads 21. As shown in FIG. 1a, interface 5 may be configured to connect to a communications medium, such as medium 4a while interface 6 may be configured to connect to a device, such as device 3a. As before, the media may be selected from the group consisting of at least coaxial cable, optical fiber, and copper cable, for example.

The threads 21 used in interface 5 may comprise threads having a range of sizes or thread gauges, depending on the type of device or element to be connected. For example, if the connector 2a is a 7/16 mini-DIN connector the thread size is M29, if the connector 2a is a 4.1/9.5 mini-DIN connector the thread size will be M20, while if the connector 2a is an N-type connector the size will be 0.625 UNEF-2A for the external threads and 0.624UNEF-2B for the internal threads, for example.

As shown in FIG. 1b, the connector 2a may also include communications contacts 10, 11 housed in body 20 for communicatively connecting elements joined thereto. For example, body 20 may include inner contact 10 and outer contact 11 that may provide a conductive path or other communication mechanism between connector 2a and devices, media and elements connected thereto, such as device 3a and medium 4a in FIG. 1a. Inner contact 10 may be a 4.1, 4.3 or 7 mm connector, and outer contact 11 may be a 9.5, 10 or 16 mm connector, for example, such that connector 2a may comprise a 4.1/9.5, 4.3/10 or a 7/16 mini-DIN connector. Alternatively, connector 2a may be an N-type connector.

In the embodiment depicted in FIG. 1b, connector 2a is a female connector though male connectors are also within the scope of the present invention. Alternatively formed, sized and shaped contacts may be used as a part of an inventive connector, where the specific contacts may depend on the types of devices, media and elements to be connected by exemplary connectors. For example, connector 2a may include male contacts, contacts with different shapes, contacts at different relative positions, and/or contacts of different sizes.

Connector 2a may further include a grounding part 12. Grounding part 12 may be configured as a ringed surface that is part of an end portion of body 20, although other configurations, shapes and positions for grounding part 12 may be utilized depending on the desired application. Grounding part 12 may be electrically connected to body 20 to provide electrical grounding for connector 2a and/or to elements connected by, or to, connector 2a.

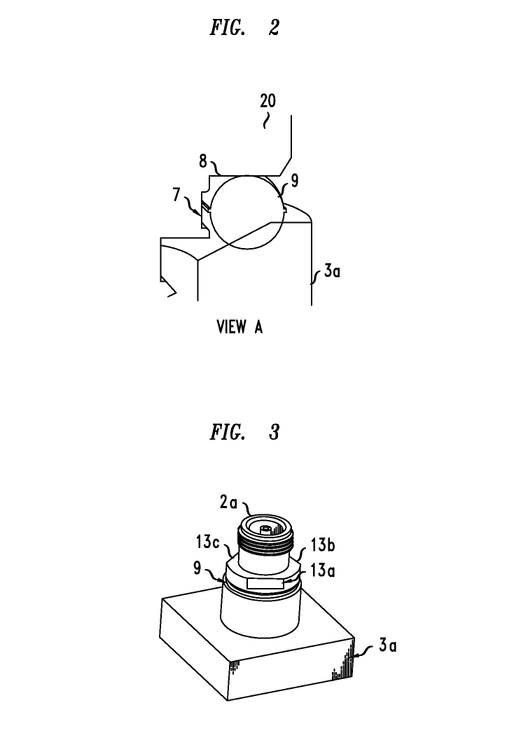

FIG. 2 depicts a simplified, enlarged cross-sectional view of a section of the body 20 of connector 2a, and member 9 shown in FIG. 1b (see “View A” in FIG. 1b). As shown, body 20 may be configured to include a recessed portion 7 of an outer surface 8 that is configured to receive and retain (i.e., retainably receive) member 9 so that the member 9 may be retained within the recessed portion 7. In more detail, the use of a recessed portion 7 reduces the chances that member 9 will move from between body 20 and a surface of device 3a (i.e., slip out) as the connector 2a is screwed into, or otherwise connected to, the device 3a due to forces being applied during such a connection process or due to forces that exist after the process is completed. As positioned, member 9 may aid in the reduction and prevention of corrosion by preventing water or other environmental elements from seeping into or otherwise forming on, the connection formed by connector 2a and device 3a. In one embodiment the seating member 9 may be an integral part of an inventive connector 2a (e.g., pre-assembled as a part of the connector 2). In another embodiment the seating member 9 may be a separate element. In the latter case, a seating member 9 may be added to the connector 2a or assembled with the connector 2a or connection.

In one embodiment member 9 may comprise a deformable O-ring that in addition to preventing and reducing corrosion also facilitates physical connection between connector 2a and device 3a. Member 9 may be generally annular and fabricated of any sufficiently flexible material, including rubber, silicone, nitrile, etc. In addition to an O-ring, member 9 may comprise, for example, a suitable washer, gasket, and/or any other plastically or elastically deformable member, provided such member may be received and retained by recessed portion 7 or perform the same function as portion 7 and member 9.

Referring now to FIG. 3, there is depicted another view of an exemplary flangeless connector, such as connector 2a, connected to an exemplary device, such as device 3a, according to another embodiment. As depicted the connector 2a may be configured with one or more grip surface portions 13a, 13b and 13c. The grip surface portions 13a, 13b, 13c may comprise flattened surface portions, raised surface portions, indents, or recessed holes, for example. Portions 13a, 13b and 13c may be gripped and then rotated using a tool (e.g., wrench) or manually by hand in order to rotatably adjust the connector 2a so that it is adequately fastened to device 3a or another medium or element.

Though three grip surface portions 13a, 13b and 13c are shown in FIG. 3 it should be understood that fewer, or more portions may be used. For example, the number of grip surface portions may be one, two, three or more, for example.

One exemplary method for connecting an inventive flangeless connector described herein, such as a threaded, flangeless mini-DIN connector or N-type connector (e.g., connector 2a) to a communications device, such as device 3a, or a medium or element is now described. Such a method may include positioning a flangeless connector at a desired connection or with a desired device or medium, the connector comprising a seating member, such as a deformable O-ring, positioned in a recessed portion formed around an outer surface of a body of the threaded, flangeless connector. As discussed above, the recessed portion may be configured to retainably receive the O-ring. In one embodiment the seating member may be an integral part of the connector (e.g., pre-assembled as a part of the connector). In another embodiment the seating member may be a separate element. In the latter case, the seating member may be added to the connector or assembled with the connector or connection. For example, the member may be initially positioned on a surface of a port or opening that is part of the device until the connector with recessed portion is placed on the port.

After the member is positioned the flangeless connector may be secured to, or into, the device a by applying a force (e.g., a rotatable force) to the one or more grip surface portions of the body using a tool, or manually by hand. The grip surface portions may aid in the reduction and prevention of corrosion by ensuring that an inventive connector is adequately fastened to a device or medium, for example, in order to prevent water or other environmental elements from seeping into or otherwise forming on, the surfaces of the connector and/or device involved in the connection.

It should be understood that inventive connectors provided by the present invention may be installed or otherwise connected to a system, device, medium or element as a separate component or, alternatively, may be made an integral part of a system, device, medium or element. For example, in one embodiment a device, such as a filter, amplifier or transmitter to name just a few types of devices, may comprise an integral, inventive connector operable to operate over a wide range of frequencies. Exemplary ranges are DC to 14 GHz (4.1/9.5 mini-DIN connector), DC to 7.5 GHz (7/16 mini-DIN connector), and 0 to 11 GHz (N-type connector) to name just a few of the many ranges within the scope of the present invention, for example.

A flangeless connector that is an integral part of a communications device (e.g., filter, amplifier, or transmitter) may include a connector body configured with two oppositely positioned connection interfaces, where: (i) at least one of the interfaces may include threads; (ii) at least one of the interfaces may be connected to the device; and (iii) another interface may be configured to connect to a communications medium (e.g., coaxial cable, optical fiber, and copper cable), for example. The body may be configured with a recessed portion formed around an outer surface of the body to retainably receive a seating member (e.g., deformable O-ring), and further be configured with one or more grip surface portions (e.g., flattened surface portions, raised surface portions, indents, or recessed holes, for example) for adjusting the connector (e.g., rotatably adjustments) so that it is adequately fastened to the device or medium. As before, in one embodiment the seating member may be an integral part of the connector (e.g., pre-assembled as a part of the device). In another embodiment the seating member is a separate element. In the latter case, a seating member may be added to the connector or assembled with the connector, device or connection.

Exemplary inventive connectors that may be made a part of an inventive device are a 4.1/9.5 mini-DIN connector, a 4.3/10 mini-DIN connector, a 7/16 mini-DIN connector or an N-type connector.

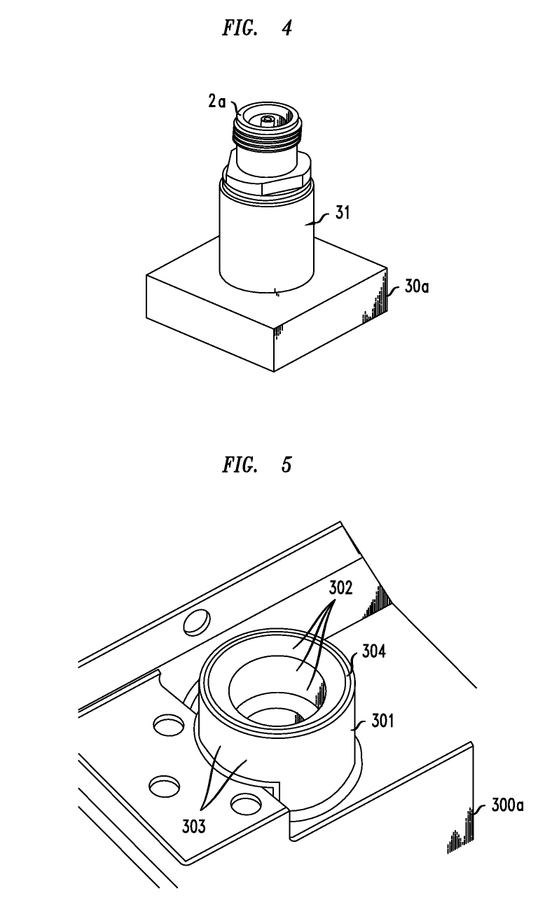

Referring now to FIG. 4 there is depicted an exemplary flangeless connector that is connected to another exemplary device according to yet another embodiment. In FIG. 4 an exemplary connector, such as connector 2a, is connected to a communications device 30a (e.g., filter, amplifier or transmitter, etc.,) that includes an extension, lengthened or extended port 31 (collectively “extended”) for receiving the connector 2a. In such an embodiment the connector 2a may retain an original length. Said another way, only the length of the port 31 needs to be increased. The use of an extended port aids in the ease of installation of a connector and helps reduce corrosion because the further away the connector 2a and port 31 are from the main sections of device 30a the less likely contaminants (e.g., salt) will build up around the port 31 and connector 2a, for example.

The present invention also provides additional, inventive devices (e.g., filter, amplifier or transmitter, etc.,) that may be used with inventive flangeless connectors. For example, FIG. 5 depicts a communications device 300a that includes an exemplary port or receptacle 301 (collectively “port”). The port 301 may be configured to receive an exemplary connector, such as connector 2a (not shown in FIG. 5). In one embodiment the inner surfaces 302 of the port 301 may comprise metallic, conductive plating while the outer surfaces 303 may not be plated. For example, the inner surfaces 302 (except for a inner surface edge 304, described below) may comprise copper plating, for example, that covers the inner surfaces 302 up to, and including a grounding part, such as part 12 in FIG. 1b. The outer surfaces 303 may comprise an aluminum or polymer surface covered by a non-conductive coating (e.g., powder coating, paint). In addition, an inner surface edge 304 which is in contact with a seating member (not shown in FIG. 5) may be covered by a non-conductive coating (e.g., powder coating, paint) as well. In this manner all of the surfaces that are plated may be protected from environmental conditions by a seal formed by a recessed, seating member and the contact surfaces of the connector (e.g., surface 8) and port 301. In contrast, the other exposed surfaces are coated or otherwise covered (i.e. treated) with a non-conductive powder coating or paint.

A variety of common materials may be used to fabricate the exemplary connectors described herein. For example, an inventive flangeless connector, such as connector 2a, may be fabricated from a tri-metal plated brass though other materials such as such as nickel, steel, aluminum, etc., or alloys thereof may be used. Alternately, an inventive connector may be fabricated from a dielectric plastic or composite if the connector is to be an insulating connector. Contacts, such as inner contact 10 and outer contact 11, may similarly be fabricated of a material having desired characteristics. For example, contacts 10 and 11 may be fabricated from a conductive material if an inventive connector is to carry or otherwise transmit or conduct an electric current. In light of the forgoing examples, it should be understood that many materials may be used in, and to form, exemplary inventive connectors.

Although exemplary flangeless connectors have been described and illustrated, it should be understood that the specific features or components shown in such exemplary connectors may be reshaped, resized, repositioned, or otherwise modified in order to be compatible with alternate applications without departing from the scope of the present invention. Further, it is understood that certain components, such as a grounding part, may be omitted entirely from an exemplary embodiment depending on the usefulness of these components or features in a particular application.

In sum, while exemplary embodiments have been shown and described herein, it should be understood that variations of the disclosed embodiments may be made without departing from the scope of the claims that follow.

We claim:

1. A flangeless, communications connector comprising:
a connector body configured with a recessed portion formed around an outer surface of the body to retainably receive a seating member.

2. The connector as in claim 1 wherein the connector comprises a mini-DIN connector or an N-type connector.

3. The connector as in claim 1 wherein the connector is further configured with one or more grip surface portions to adjust the connector.

4. The connector as in claim 3 wherein the one or more grip surface portions comprise flattened surface portions, raised surface portions, indents, or recessed holes.

5. The connector as in claim 1 further comprising a seating member.

6. The connector as in claim 5 wherein the seating member comprises a deformable O-ring.

7. The connector as in claim 1 wherein the body is further configured with two oppositely positioned connection interfaces, where at least one of the oppositely positioned interfaces comprises threads.

8. A communications device comprising:
a flangeless, communications connector comprising,
a connector body configured with a recessed portion formed around an outer surface of the body to retainably receive a seating member, and further configured with one or more grip surface portions to adjust the connector.

9. The device as in claim 8 wherein the connector comprises a mini-DIN connector or an N-type connector.

10. The device as in claim 8 wherein the one or more grip surface portions comprise flattened surface portions, raised surface portions, indents, or recessed holes.

11. The device as in claim 8 further comprising a seating member.

12. The device as in claim 11 wherein the seating member comprises a deformable O-ring.

13. The device as in claim 8 wherein the body is further configured with two oppositely positioned connection interfaces, where at least one of the two oppositely positioned interfaces comprises threads.

14. The device as in claim 8 wherein the device is selected from the group consisting of at least a filter, an amplifier and a transmitter.

15. The device as in claim 8 further comprising a port configured to receive the connector, wherein inner surfaces of the port comprise a conductive plating and outer surfaces of the port comprise a non-conductive coating.

16. The device as in claim 15 wherein the conductive plating comprises copper plating.

17. The device as in claim 8 further comprising an extended port for receiving the connector.

18. A communications device comprising:
a port configured to receive a flangeless, communications connector, wherein inner surfaces of the port comprise a conductive plating and outer surfaces of the port comprise a non-conductive coating.

19. The device as in claim 18 wherein the conductive plating comprises copper plating.

20. A method for connecting a flangeless, communications connector to a communications device comprising:
positioning a threaded, flangeless communications connector, the connector comprising a recessed portion formed around an outer surface of a body of the connector to retainably receive a deformable seating member; and
securing the connector to, or into, a communications device by applying a force to grip surface portions of the body.
